(19) United States
(12) Patent Application Publication
(10) Pub. No.: US 2010/0298013 A1
(43) Pub. Date: Nov. 25, 2010

(54) METHOD, SYSTEM, AND APPARATUS FOR IMPLEMENTING SHORT MESSAGE FREEPHONE SERVICE

(75) Inventor: Jinwu Cao, Shenzhen (CN)

Correspondence Address: Docket Clerk/HTCL, P.O. Drawer 800889, Dallas, TX, 75380, US

(73) Assignee: Huawei Technologies Co., Ltd.

(21) Appl. No.: 12/848,870

(22) Filed: Aug. 2, 2010

Related U.S. Application Data
(63) Continuation of application No. PCT/CN2009/070066, filed on Jan. 7, 2009.

(30) Foreign Application Priority Data
Feb. 2, 2008 (CN) 200810006833.3

(51) Int. Cl. H04W 4/14

(52) U.S. Cl. 455/466

(57) ABSTRACT

A method for implementing a message FPH service includes: receiving a message from a sender, and authenticating the message recipient for paying; deducting an expense from the account of the message recipient after the authentication succeeds; and sending the message to the recipient after the expense is deducted successfully. Further, a system and an apparatus for implementing a message FPH service are disclosed herein. The technical solution under the present invention enables the message recipient to pay for the short message instead of the sender, thus enriching the services of the operator, improving the competitiveness of the operator, and helping the operator expand the market and attract more users.

### CROSS-REFERENCE TO RELATED APPLICATIONS

This application is a continuation of International Application No. PCT/CN2009/070066, filed on Jan. 7, 2009, which claims priority to Chinese Patent Application No. 200810006833.3, filed on Feb. 2, 2008, both of which are hereby incorporated by reference in their entireties.

### TECHNICAL FIELD

The present invention relates to mobile communication, and in particular, to a method, a system, and an apparatus for implementing a short message FreePhone (FPH) service.

### BACKGROUND

According to the recipient and the user roaming state, the basic Peer-to-Peer (P2P) short message service falls into: intra-network P2P short message service, inter-network P2P short message service, international short message service, and international roaming of short message service. The charge for any of such P2P short message services is payable by the sender, and the recipient receives the short message free of charge.

In the process of developing the present invention, the inventor finds at least the following defects in the prior art:
In conventional technology, the charge for P2P short message services is payable by the sender, and the services are simplex and do not support a recipient to pay the charge for the short message, and cannot meet different requirements of different users.

### SUMMARY

The embodiments of the present invention provide a method, a system, and an apparatus for implementing a message FPH service to let the message recipient pay for the service instead of the sender.

A method for implementing a message FPH service includes:
receiving a message from a sender, and authenticating the message recipient for paying;
deducting an expense from the account of the message recipient after the authentication succeeds; and
sending the message to the recipient after the expense is deducted successfully.

A system for implementing a message FPH service includes:
a message forwarding apparatus, adapted to: receive a message from the sender, identify a message FPH identifier in the message, forward the message to a message FPH apparatus, and send the message to the recipient after receiving a confirmation instruction from the message FPH apparatus;
a message FPH apparatus, adapted to: authenticate the message recipient for paying for the message forwarded by the message forwarding apparatus, send a deduction instruction to a charging apparatus after the authentication succeeds, and send a message sending confirmation instruction to the message forwarding apparatus after the charging apparatus deducts the expense successfully; and
a charging apparatus, adapted to receive the deduction instruction from the message FPH apparatus, deduct an expense from the account of the recipient according to the message sent by the sender, and feed back a result of deduction.

A message forwarding apparatus is provided in an embodiment of the present invention. The message forwarding apparatus includes:
an identifier identifying module, adapted to identify the message FPH identifier in the message sent by the sender; and
a message forwarding module, adapted to: forward the message which carries a message FPH identifier identified by the identifier identifying module to the message FPH apparatus, and send the message to the recipient after the message FPH apparatus confirms success of deducting the expense.

A message FPH apparatus is provided in an embodiment of the present invention. The message FPH apparatus includes:
an authenticating module, adapted to authenticate the message recipient for paying for the message forwarded by the message forwarding apparatus;
a charging apparatus, adapted to: send a deduction instruction to the charging apparatus after the authentication is performed by the authenticating module successfully, and receive the deduction result fed back by the charging apparatus; and
a sending confirming module, adapted to send a message sending instruction to the message forwarding apparatus when the deduction result received by the charging module indicates success.

Compared with the conventional technology, the technical solution under the present invention implements the message FPH service, and enables the message recipient to pay for the short message instead of the sender, thus enriching the services of the operator, improving the competitiveness of the operator, and helping the operator expand the market and attract more users.

### BRIEF DESCRIPTION OF THE DRAWINGS

FIG. 1 is a flowchart of activating a message FPH service in the first embodiment of the present invention;

FIG. 2 is a flowchart of authentication which requires the recipient to confirm manually after an SMSC forwards a short message in the second embodiment of the present invention;

FIG. 3 is a flowchart of authentication which requires the recipient to confirm manually after a switch forwards a short message in the third embodiment of the present invention;

FIG. 4 is a flowchart of authentication which requires an SMSFPH to confirm automatically after an SMSC forwards a short message in the fourth embodiment of the present invention;

FIG. 5 shows a structure of a message FPH system in the sixth embodiment of the present invention;

FIG. 6 shows a structure of a message forwarding apparatus in the seventh embodiment of the present invention; and

FIG. 7 shows a structure of a message FPH apparatus in the eighth embodiment of the present invention.

### DETAILED DESCRIPTION

The embodiments of the present invention provide a method, a system, and an apparatus for implementing a message FPH service to enable the recipient to pay for the short message instead of the sender, enrich the services of the operator and facilitate users.

For brevity of description, in the embodiments of the present invention, all the services which require the message recipient to pay are collectively called “message FPH service”, the message FPH apparatus is exemplified by a Short Message Service Free Phone (SMSFPH) system, and the message service center is exemplified by a Short Message Service Center (SMSC).

For other message services such as Multimedia Messaging Service (MMS), the FPH service can also be implemented through the technical solution provided herein. In the scenario of the MMS, the SMSFPH system needs to be replaced with Multimedia Messaging Service Free Phone (MMSFPH) system, and the SMSC needs to be replaced with Multimedia Messaging Service Center (MMSC), but the principles for implementing the FPH service are the same, and the corresponding technical solution is covered by the protection scope of the present invention.

The embodiments of the present invention are detailed below with reference to accompanying drawings.

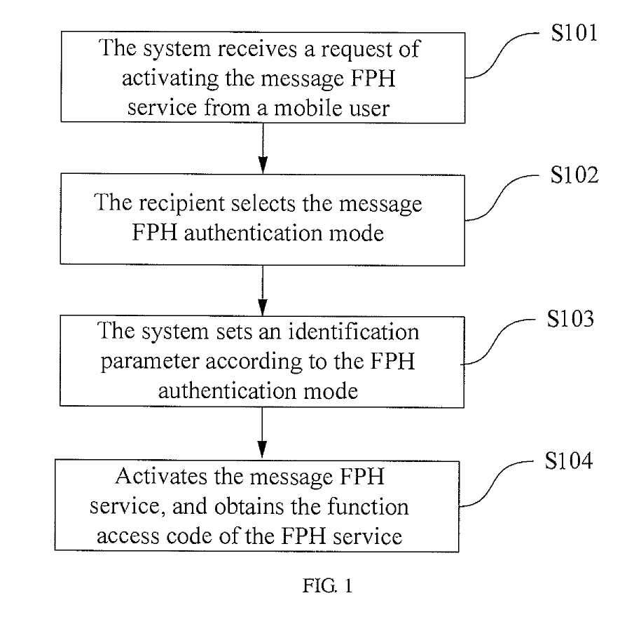

FIG. 1 is a flowchart of activating a message FPH service in the first embodiment of the present invention. The activation process includes the following steps:

Step S101: The system receives a request of activating the message FPH service from a mobile user.

The mobile user may be a personal user or an enterprise user.

Step S102: The system receives the FPH service authentication mode selected by the mobile user. The mobile user may select one of the following four authentication modes:

A. Recipient confirmation

When the user activates the message FPH service, the system asks the user to select an authentication mode. The user may select the recipient confirmation authentication mode as required. When the sender A sends a short message which requires a message FPH service to recipient B, the SMSFPH system sends a short message notification to recipient B. The short message notification indicates that sender A is sending a short message to recipient B, and asks whether recipient B agrees to pay for the short message. Recipient B returns a “Yes” message if he/she agrees, or else returns a “No” message. In practice, the number from which the SMSFPH system sends a short message may be “function access code of message FPH+customer service number of the operator”, or specified by the operator uniformly.

If recipient B agrees to pay for the short message, the SMSFPH system forwards the short message to recipient B; if recipient B rejects to pay for the short message, the SMSFPH system sends a prompting message to the sender, for example, “Recipient B rejects to pay for the short message”, and notifies sender A that the sending fails.

B. Name list confirmation, including two scenarios:

When the user activates the message FPH service, the user may set a blacklist or a whitelist of senders.

If the user sets a blacklist, the SMSFPH system authenticates sender A. If sender A is not included in the blacklist, the SMSFPH system allows recipient B to pay for the short message of sender A, and sends the short message to recipient B after deducting the expense automatically; otherwise, the SMSFPH notifies sender A of the sending failure.

If the user sets a whitelist, the SMSFPH system authenticates sender A. If sender A is included in the whitelist, the SMSFPH system allows recipient B to pay for the short message of sender A, and sends the short message to recipient B after deducting the expense automatically; otherwise, the SMSFPH system notifies sender A of the sending failure.

C. Area confirmation, namely, the recipient is authenticated according to the home area of the sender.

When the user activates the message FPH service, the user may set free areas of the message FPH service. Recipient B pays for the short message of sender A only if sender A belongs to the set free areas.

D. Time segment confirmation, namely, the recipient is authenticated according to the time segment.

When the user activates the message FPH service, the user may set free time segments of the message FPH service. Recipient B pays for the short message of sender A only if sender A sends the short message to recipient B in the free time segments.

Mode A is a manual authentication mode, and requires manual confirmation of the recipient; modes B, C, and D are automatic authentication modes, and the SMSFPH system authenticates the message FPH service of the sender automatically according to the identification parameters pre-set by the recipient.

Step S103: The system sets an identification parameter according to the FPH service authentication mode selected by the user.

The system sets an identification parameter automatically according to the FPH service authentication mode selected by the user, as detailed below.

If the user selects a name list confirmation authentication mode, the SMSFPH system sets the sender blacklist identification parameter or whitelist identification parameter according to the blacklist or the whitelist of senders set by the user. The SMSFPH system checks whether to allow recipient B to pay for the short message of sender A according to the identification parameter.

If the user selects an area confirmation authentication mode, the SMSFPH system sets the free area identification parameter according to the free areas of the message FPH service set by the user. The SMSFPH system checks whether to allow recipient B to pay for the short message of sender A according to the identification parameter.

If the user selects a time segment confirmation authentication mode, the SMSFPH system sets the free time segment identification parameter according to the free time segments of the message FPH service set by the user. The SMSFPH system checks whether to allow recipient B to pay for the short message of sender A according to the identification parameter.

Step S104: The recipient activates the FPH service, and obtains the function access code of the message FPH service.

The operator provides a unified function access code (such as 400) for the message FPH service. If sender A knows that recipient B has activated the message FPH service, sender A may send the short message to “short message 400+the number of B” when sending the short message to recipient B.

With the unified function access code, the operator enhances the brand of the message FPH service, and publicizes the service to users conveniently. By sending a short message to the unified 400 number, the users can participate more conveniently. When the enterprise user publicizes its message FPH service number, the consumers feel that it is secure to send a short message to the “short message 400+enterprise number” to consult about relevant services.

If the recipient B has not activated the message FPH service or the message FPH service of recipient B does not serve the sender A, the system sends an indication to the sender A, where the indication is that: “Recipient B does not pay for the short message, and the sending fails”.

In practice, there are two types of message forwarding apparatuses: SMSC and switch. The two types of the message forwarding apparatuses forward messages in the modes described separately in different embodiments, and are further differentiated according to the foregoing manual authentication mode and automatic authentication mode.

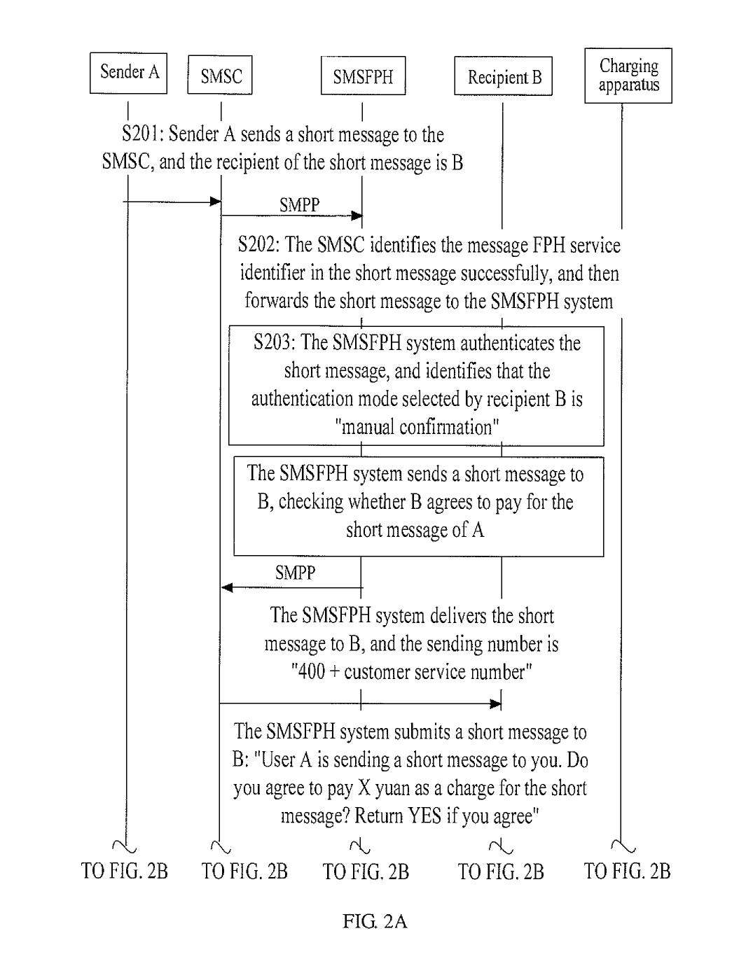

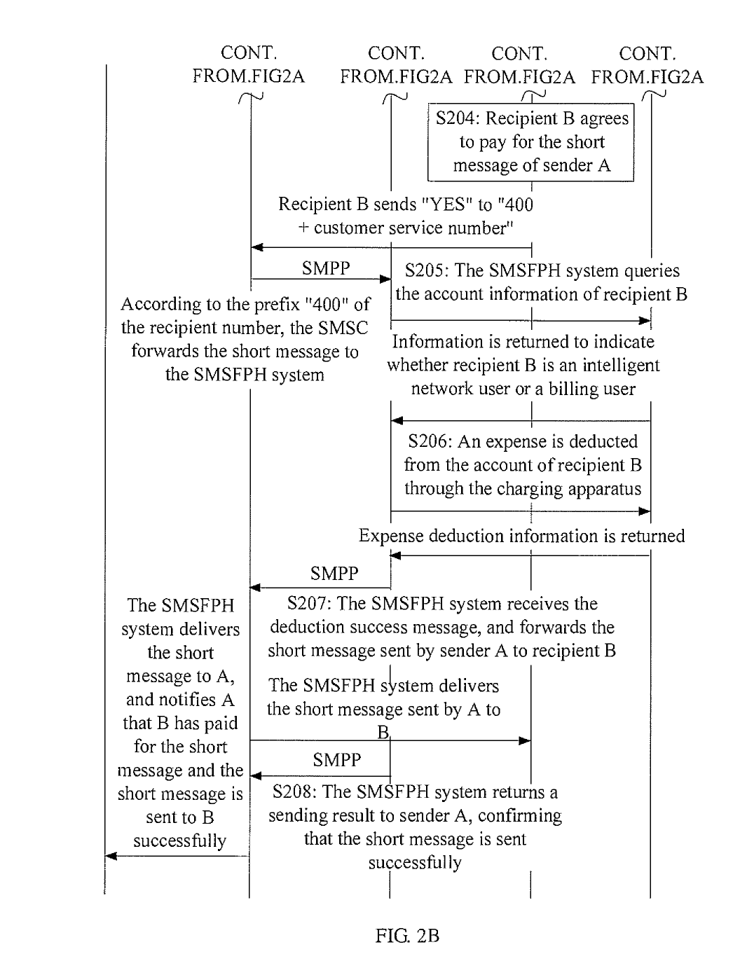

FIG. 2 is a flowchart of authentication that requires the recipient to confirm manually after an SMSC forwards a short message in the second embodiment of the present invention. As shown in FIG. 2, the authentication process includes the following steps:

Step S201: Sender A sends a short message to the SMSC, and the recipient of the short message is B. For this short message, sender A expects recipient B to pay. The format of the number of recipient B is the “short number 400+number of B”. “400” is a unified function access code provided by the operator for the message FPH service, and is adjustable as required by the operator.

Step S202: The SMSC identifies the message FPH service identifier in the short message, and then forwards the short message to the SMSFPH system.

The message FPH service identifier is the unified function access code “400” provided by the operator for the message FPH service in step S201.

In this step, if the short message carries no message FPH service identifier, the SMSC does not forward the short message to the SMSFPH system, but deducts the expense from the account of sender A directly, and sends the message to recipient B.

Step S203: The SMSFPH system authenticates the short message.

The SMSFPH system identifies that the authentication mode selected by recipient B is “recipient confirmation”, sends a deduction confirmation message to recipient B, and checks whether recipient B agrees to pay for the short message of sender A.

In practice, the deduction confirmation message sent by the SMSFPH system to recipient B needs to be forwarded by the SMSC. The sending number may be set to “400+operator's customer service number”.

After authenticating the short message, if the SMSFPH system finds that recipient B has not activated the message FPH service or the message FPH service does not serve recipient B, the SMSFPH system sends “Recipient B does not pay for the short message, and the sending fails” to sender A directly.

Step S204: Recipient B agrees to pay for the short message of sender A. After receiving the message of agreeing to pay for the short message from recipient B, the SMSFPH system queries the system information about recipient B paying for the short message of sender A, and finds the sending number for which recipient B pays.

The SMSFPH system authenticates the number of recipient B, and judges whether recipient B has activated the message FPH service. If recipient B has activated the message FPH service, the SMSFPH system needs to perform authentication and expense deduction at the charging apparatus subsequently.

If the SMSFPH system receives a message from the recipient indicating rejection of paying, the SMSFPH system rejects to forward the short message to the recipient, and notifies the sender that the sending fails.

In practice, the deduction confirmation message may carry information that prompts the recipient to confirm, for example, “User A is sending a short message to you. Do you agree to pay X yuan as a charge for the short message? Return YES if you agree, or return NO if you reject”.

A response time may be set in this step. When recipient B does not answer the deduction confirmation message within the response time, the system automatically identifies that recipient B rejects to pay for the short message of sender A. The setting of a response time avoids these problems: The short message stays in the SMSFPH system for a long period, which leads to waste of the network resources and makes the sender unable to know whether the short message is sent successfully.

If the recipient answers the confirmation message within the response time, the SMSFPH system may confirm whether the recipient agrees to pay for the short message of the sender according to the message. For example, if the answer from recipient B is “YES”, the SMSFPH system confirms that recipient B agrees to pay for the short message of sender A, and proceeds to step S205. If the answer from recipient B is “NO”, the SMSFPH system confirms that recipient B rejects to pay for the short message of sender A, sends a prompting message to sender A, for example, “Recipient B does not pay for the short message, and the sending fails”, and deletes this short message stored in the network.

The answer needs to be forwarded by the SMSC, and the format of the number is “400+operator's customer service number”, which facilitates the SMSC to identify the information attribute and confirm the forwarding target.

Step S205: The SMSFPH system queries the account information of recipient B.

Account information includes: account attribute and account balance.

Through this step, the SMSFPH system checks whether recipient B is an intelligent network user or a billing user, and checks whether the account balance of recipient B is enough for paying for the short message of sender A.

If the account balance of recipient B is not enough for paying for the short message of sender A and the account of recipient B does not support overdraft payment, the SMSFPH system sends a prompting message to recipient B, for example, “Account balance is not enough for paying” to recipient B, and sends a prompting message to sender A, for example, “The account balance of recipient B is not enough for paying for the short message, and the sending fails”.

If the account balance of recipient B meets the requirement of paying for the short message of sender A, the query information is fed back to the SMSFPH system, and the procedure proceeds to step S206.

Step S206: An expense is deducted from the account of recipient B through the charging apparatus.

After deducting the expense successfully, the charging apparatus sends a deduction success message to the SMSFPH system.

If the deduction fails, the charging apparatus sends “Recipient B does not pay for the short message, and the sending fails” to sender A.

Step S207: The SMSFPH system receives the deduction success message, and forwards the short message sent by sender A to recipient B.

The short message needs to be forwarded by the SMSC.

Step S208: The SMSFPH system returns a sending result to sender A, confirming that the short message is sent successfully.

The sending result needs to be forwarded by the SMSC.

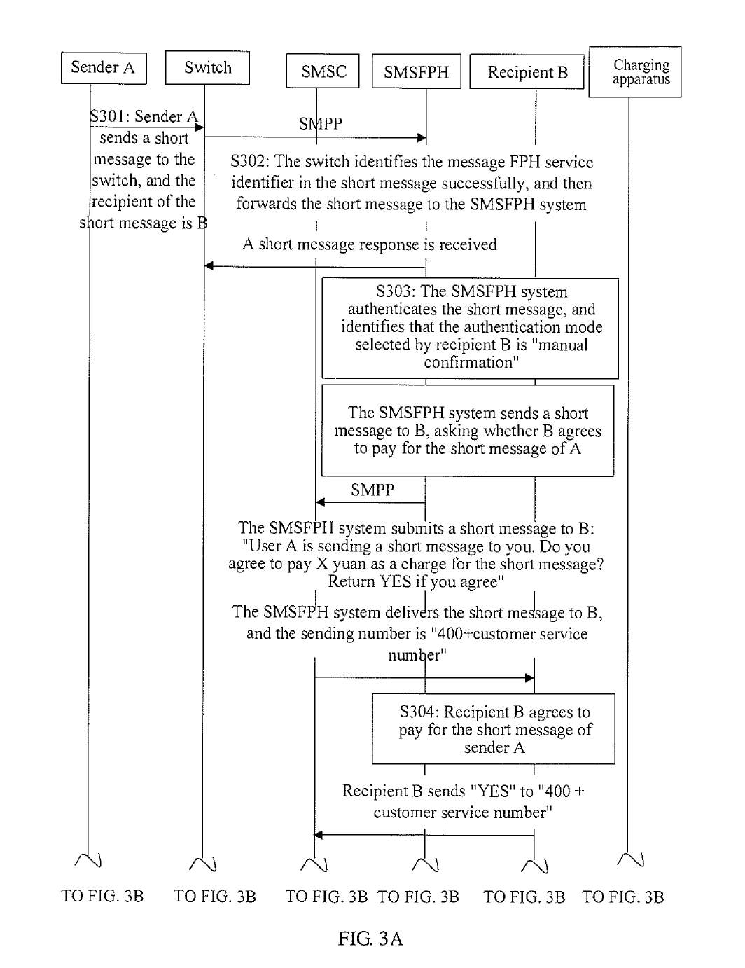

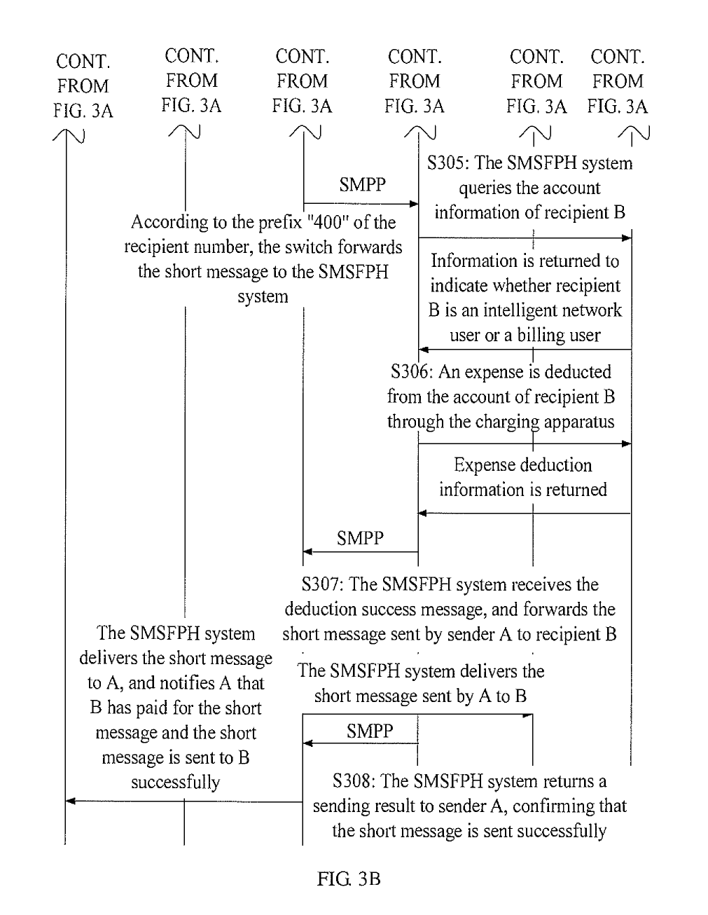

FIG. 3 is a flowchart of authentication that requires the recipient to confirm manually after a switch forwards a short message in the third embodiment of the present invention. In this embodiment, a switch takes the place of the SMSC to forward the short message. Specifically, the switch receives the short message sent by sender A to recipient B, identifies the message FPH service identifier in the short message, and then forwards the short message to the SMSFPH system. The subsequent steps are the same as those in the scenario of the SMSC forwarding the short message, and are not repeated here any further.

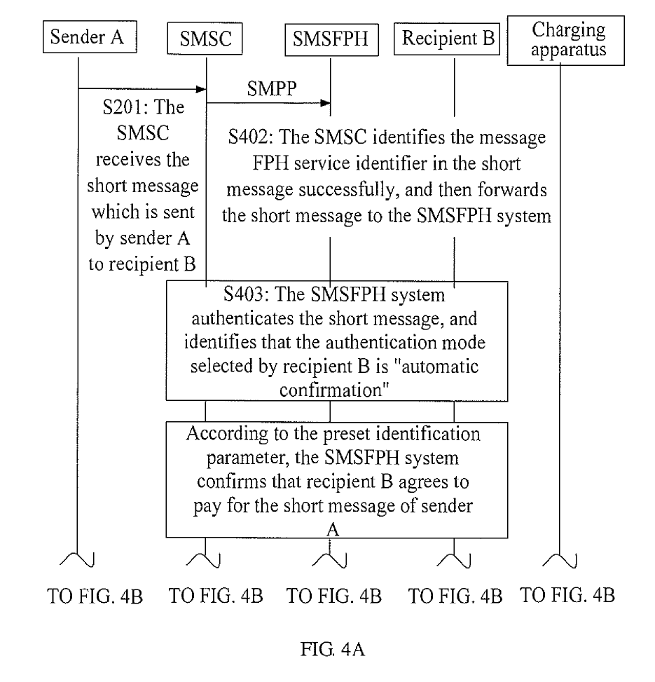

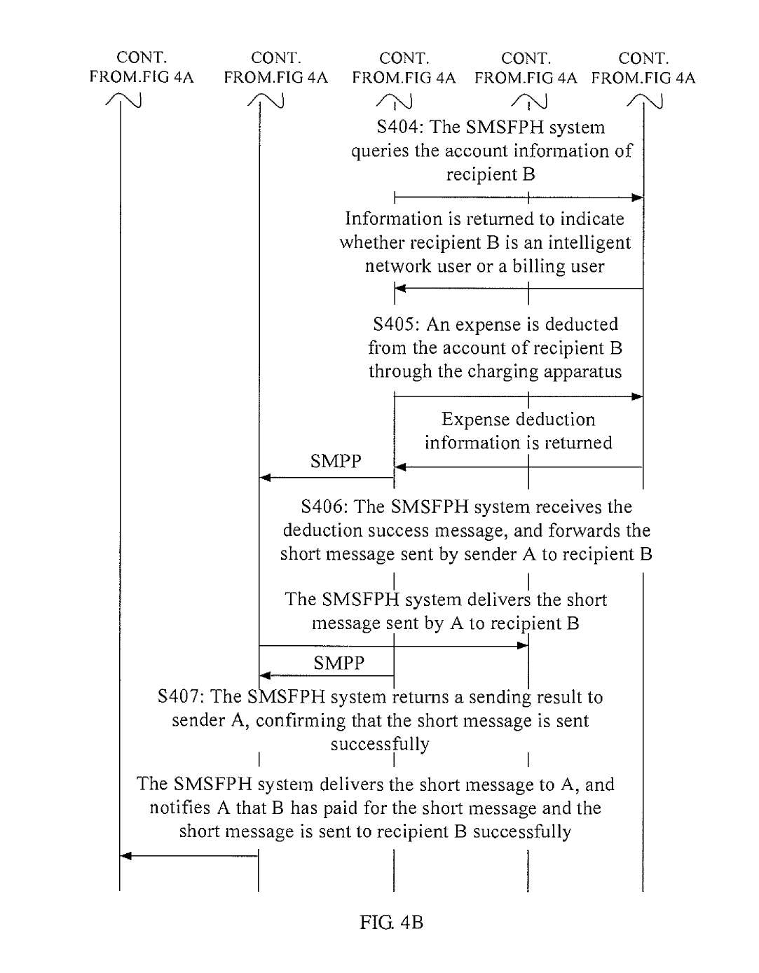

FIG. 4 is a flowchart of authentication that requires an SMSFPH system to confirm automatically after an SMSC forwards a short message in the fourth embodiment of the present invention. The authentication process includes the following steps:

Step S401: The SMSC receives the short message that is sent by sender A to recipient B.

For this short message, sender A expects recipient B to pay. The format of the number of recipient B is the “short number 400+number of B”. “400” is a unified function access code provided by the operator for the message FPH service, and is adjustable as required by the operator.

Step S402: The SMSC identifies the message FPH service identifier in the short message, and then forwards the short message to the SMSFPH system.

The message FPH service identifier is the unified function access code “400” provided by the operator for the message FPH service in step S401.

In this step, if the short message carries no message FPH service identifier, the SMSC does not forward the short message to the SMSFPH system, but deducts the expense from the account of sender A directly, and sends the message to recipient B.

In this step, if the short message carries a message FPH service identifier but the SMSFPH system finds that recipient B has not activated the message FPH service or the message FPH service does not serve recipient B after authenticating the short message, the SMSFPH system sends “Recipient B does not pay for the short message, and the sending fails” to sender A directly.

Step S403: The SMSFPH system authenticates the short message.

The SMSFPH system identifies that the authentication mode selected by recipient B is “automatic confirmation”, and checks whether recipient B agrees to pay for the short message of sender A according to the preset identification parameter.

There are four authentication modes, as described below:

If recipient B selects a blacklist automatic authentication mode, the SMSFPH system performs authentication according to the set blacklist. If sender A is not included in the blacklist, the SMSFPH system allows recipient B to pay for the short message of sender A.

If recipient B selects a whitelist automatic authentication mode, the SMSFPH system performs authentication according to the set whitelist. If sender A is included in the whitelist, the SMSFPH system allows recipient B to pay for the short message of sender A.

If recipient B selects an area confirmation authentication mode, the SMSFPH system checks whether sender A belongs to the set free areas of the message FPH service. Recipient B agrees to pay for the short message of sender A only if sender A belongs to the set free areas.

If recipient B selects a time segment confirmation authentication mode, the SMSFPH system checks whether sender A sends the short message in the set free time segments of the message FPH service. Recipient B agrees to pay for the short message of sender A only if sender A sends the short message to recipient Bin the free time segments.

If none of the foregoing circumstances is applicable, it is deemed that recipient B rejects to pay for the short message of sender A.

Step S404: The SMSFPH system queries the account information of recipient B.

Account information includes: account attribute and account balance.

Through this step, the SMSFPH system checks whether recipient B is an intelligent network user or a billing user, and checks whether the account balance of recipient B is enough for paying for the short message of sender A.

If the account balance of recipient B is not enough for paying for the short message of sender A and the account of recipient B does not support overdraft payment, the SMSFPH system sends a prompting message to recipient B, for example, “Account balance is not enough for paying”, and sends a prompting message to sender A, for example, “The account balance of recipient B is not enough for paying for the short message, and the sending fails”.

If the account balance of recipient B meets the requirement of paying for the short message of sender A, the query information is fed back to the SMSFPH system, and the procedure proceeds to step S405.

Step S405: An expense is deducted from the account of recipient B through the charging apparatus.

After deducting the expense, the charging apparatus sends a deduction success message to the SMSFPH system.

Step S406: The SMSFPH system receives the deduction success message, and forwards the short message sent by sender A to recipient B.

The short message needs to be forwarded by the SMSC.

Step S407: The SMSFPH system returns a sending result to sender A, confirming that the short message is sent successfully.

The sending result needs to be forwarded by the SMSC.

The SMSC that forwards the short message may be replaced with a switch. The switch forwards the short message and the SMSFPH system confirms the authentication automatically, which is the fifth embodiment of the present invention. The detailed implementation process in the fifth embodiment is similar to that in the fourth embodiment, and is not repeated here any further.

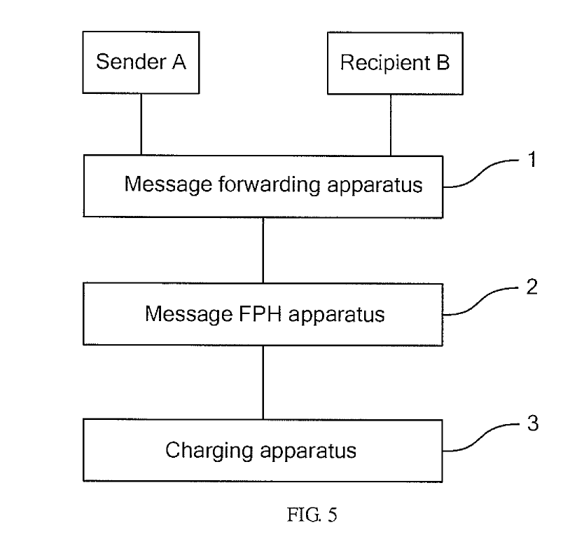

FIG. 5 shows a structure of a message FPH system in the sixth embodiment of the present invention. The system enables recipient B to pay for the short message of sender A, and includes:
a message forwarding apparatus 1, adapted to: receive a message from sender A, identify a message FPH identifier in the message, forward the message to a message FPH apparatus 2, and send the message to recipient B after receiving a confirmation instruction from the message FPH apparatus 2;
a message FPH apparatus 2, adapted to: authenticate the message recipient for paying for the message forwarded by the message forwarding apparatus 1, send a deduction instruction to a charging apparatus 3 after the authentication succeeds, and send a message sending confirmation instruction to the message forwarding apparatus 1 after the charging apparatus 3 deducts the expense successfully; and
a charging apparatus 3, adapted to receive the deduction instruction from the message FPH apparatus 2, deduct an expense from the account of recipient B according to the message sent by sender A, and feed back a result of deduction.

In practice, the message forwarding apparatus 1 may be configured in two ways:

The first configuration of the message forwarding apparatus is an SMSC, or an MMSC, or another message service center.

The second configuration of message forwarding apparatus includes:
a switch, adapted to: receive a message sent by sender A, identify the message FPH identifier in the message, and forward the message to the message FPH apparatus 2; and
an SMSC or MMSC or another message service center, adapted to send the message to recipient B after receiving a confirmation instruction from the message FPH apparatus 2.

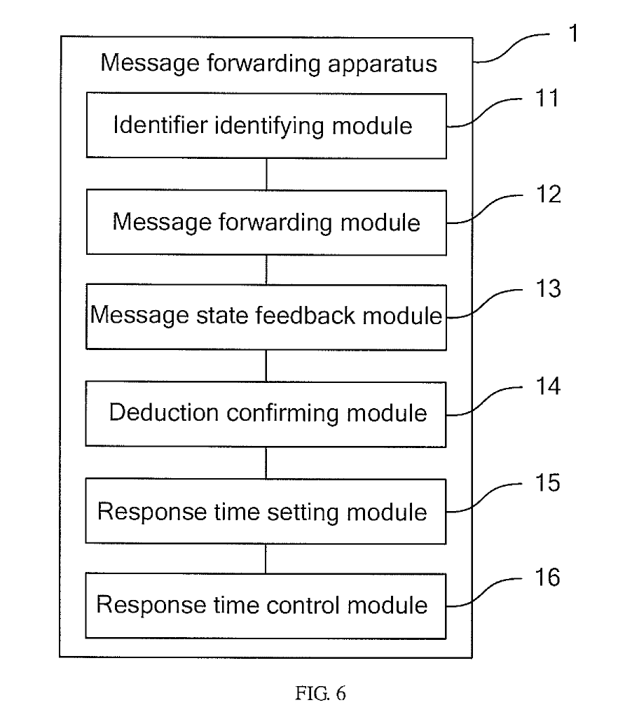

FIG. 6 shows a structure of a message forwarding apparatus 1 in the seventh embodiment of the present invention. The message forwarding apparatus 1 includes:
an identifier identifying module 11, adapted to identify the message FPH identifier in the message sent by sender A; and
a message forwarding module 12, adapted to: forward the message which carries a message FPH identifier identified by the identifier identifying module 11 to the message FPH apparatus 2, and send the message to recipient B after the message FPH apparatus 2 confirms success of deducting the expense.

The message forwarding apparatus 1 further includes:
a message state feedback module 13, adapted to feed back the state of processing the message to sender A according to the processing result of the identifier identifying module 11 and the message forwarding module 12.

When the message FPH authentication mode selected by recipient B is “recipient confirmation”, the message forwarding apparatus 1 further includes:
a deduction confirming module 14, adapted to: send a deduction confirmation message to recipient B, and receive the answer returned by recipient B in response to the deduction confirmation message;
a response time setting module 15, adapted to set a response time; and
a response time control module 16, adapted to determine that recipient B rejects to pay for the short message of sender A if the recipient B does answer the deduction confirmation message within the response time.

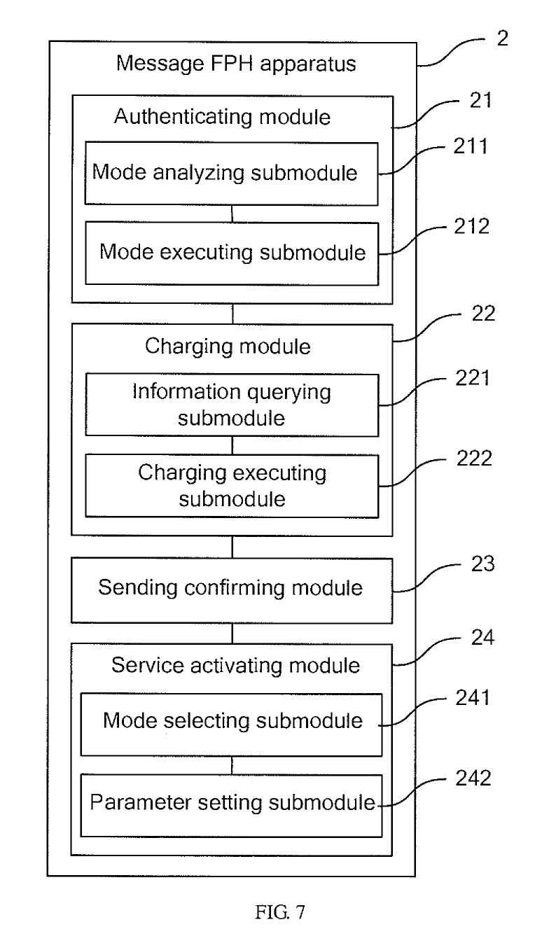

FIG. 7 shows a structure of a message FPH apparatus 2 in the eighth embodiment of the present invention. The apparatus 2 includes:
an authenticating module 21, adapted to authenticate the message recipient for paying for the message forwarded by the message forwarding apparatus 1;
a charging apparatus 22, adapted to: send a deduction instruction to the charging apparatus 3 after the authentication is performed by the authenticating module 21 successfully, and receive the deduction result fed back by the charging apparatus 3; and
a sending confirming module 23, adapted to send a message sending instruction to the message forwarding apparatus 1 when the deduction result received by the charging module 22 indicates success.

The authenticating module 21 includes:
a mode analyzing submodule 211, adapted to analyze the message FPH authentication mode of recipient B and generate an analysis result; and
a mode executing submodule 212, adapted to execute the message FPH authentication mode and authenticate according to the analysis result of the mode analyzing submodule 211.

The charging module 22 includes:
an information querying submodule 221, adapted to query the charging apparatus 3 about the account information of recipient B; and
a charging executing submodule 222, adapted to send a deduction command to the charging apparatus 3 according the message sent by sender A.

The message FPH apparatus 2 further includes:
a service activating module 24, adapted to activate the message FPH service for recipient B and select the message FPH authentication mode.

The service activating module 24 includes:
a mode selecting submodule 241, adapted to select the message FPH authentication mode of the message FPH service for recipient B; and
a parameter setting submodule 242, adapted to set an authorized name list or free areas or free time segments according to the message FPH authentication mode selected by the mode selecting submodule 241.

Compared with the prior art, the technical solution under the present invention brings at least these benefits: The method for implementing the message FPH service is applied to enable the message recipient to pay for the short message instead of the sender, thus enriching the services of the operator, improving the competitiveness of the operator, and helping the operator expand the market and attract more users.

After reading the foregoing embodiments, those skilled in the art are clearly aware that the present invention may be implemented through hardware, or through software in addition to a necessary universal hardware platform. Therefore, the technical solution under the present invention may be embodied as a software product. The software product may be stored in a non-volatile storage medium (such as CD-ROM, USB flash disk, or mobile hard disk), and may include several instructions that enable a computer device (such as personal computer, server, or network device) to perform the methods provided in the embodiments of the present invention.

Although the invention has been described through several preferred embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A method for implementing a message FreePhone (FPH) service, the method comprising:
receiving a message from a sender, and authenticating the message recipient for paying;
deducting an expense from the account of the recipient after the authentication succeeds; and
sending the message to the recipient after the expense is deducted successfully.

2. The method of claim 1 further comprising: sending a prompting message to the sender when the authentication fails, wherein the prompting message prompts the sender that the recipient pay for the message unsuccessfully and the sending fails.

3. The method of claim 1, further comprising: sending a prompting message to the sender when the expense is deducted unsuccessfully, wherein the prompting message prompts the sender that the recipient pay for the message unsuccessfully and the sending fails.

4. The method of claim 1, wherein the authenticating the message recipient for paying further comprises: identifying the message FPH service identifier in the message.

5. The method of claim 4, further comprising: analyzing the message FPH authentication mode of the recipient and generating an analysis result when the message FPH service identifier is identified successfully;
confirming that the recipient agrees to pay for the message according to the analysis result;
confirming that the authentication of the message FPH succeeds when the recipient agrees to pay for the message.

6. The method of claim 4 wherein the message FPH service identifier is preset uniformly, comprising:
adding a function access code of message FPH before the number of the recipient when the sender sends the message to the recipient.

7. The method of claim 5, wherein the message FPH service identifier is preset uniformly, comprising:
adding a function access code of message FPH before the number of the recipient when the sender sends the message to the recipient.

8. The method of claim 5, wherein the message FPH service authentication modes comprises:
a recipient confirmation authentication mode, wherein the recipient confirms manually whether to pay for the message of the sender by the recipient;
a name list confirmation authentication mode, wherein the recipient is confirmed whether to pay for the message of the sender by authenticating the sender according to an authentication name list;
an area confirmation authentication mode, wherein the recipient is confirmed whether to pay for the message of the sender by checking whether sender A belongs to the set free areas of the message FPH service;
a time segment confirmation authentication mode, wherein the recipient is confirmed whether to pay for the message of the sender by checking whether the sender sends the message in the set free time segments of the message FPH service.

9. The method of claim 8, wherein the confirming whether to pay for the message of the sender by the recipient manually comprises:
sending a deduction confirmation message to the recipient, and confirming whether the recipient agrees to pay for the message of the sender;
receiving a answer returned by the recipient in response to the deduction confirmation message; and
generating a confirming result according to the answer.

10. The method of claim 9, wherein the confirming whether to pay for the message of the sender by the recipient manually further comprises:
determining that the recipient rejects to pay for the short message of the sender if the recipient does not answer the deduction confirmation message within the response time.

11. The method of claim 8, further comprising:
selecting a message FPH service authentication mode when the recipient activates the message FPH service; and
setting an authorized name list or free areas or free time segments according to the message FPH authentication mode selected.

12. A system for implementing a message FreePhone (FPH) service, the system comprising:
a message forwarding apparatus, adapted to receive a message from a sender, identify a message FPH identifier in the message, forward the message to a message FPH apparatus, and send the message to a recipient after receiving a confirmation instruction from the message FPH apparatus;
the message FPH apparatus, adapted to authenticate the message recipient for paying for the message forwarded by the message forwarding apparatus, send a deduction instruction to a charging apparatus after the authentication succeeds, and send a message sending confirmation instruction to the message forwarding apparatus after the charging apparatus deducts the expense successfully; and
the charging apparatus, adapted to receive the deduction instruction from the message FPH apparatus, deduct an expense from the account of the recipient according to the message sent by the sender, and feed back a result of deduction.

13. The system of claim 12, wherein the message forwarding apparatus comprises:
a switch, adapted to receive a message sent by the sender, identify the message FPH identifier in the message, and forward the message to the message FPH apparatus; and
a Short Message Service Center (SMSC) or a Multimedia Messaging Service Center (MMSC), adapted to send the message to the recipient after receiving a confirmation instruction from the message FPH apparatus.

14. A message forwarding apparatus, comprising:
an identifier identifying module, adapted to identify a message FPH identifier in a message sent by the sender; and
a message forwarding module, adapted to forward the message which carries the message FPH identifier identified by the identifier identifying module to the message FPH apparatus, and send the message to the recipient after the message FPH apparatus confirms success of deducting the expense.

15. The message forwarding apparatus of claim 14, further comprising:
a message state feedback module, adapted to feed back the state of processing the message to the sender according to the processing result of the identifier identifying module and the message forwarding module.

16. The message forwarding apparatus of claim 14, wherein, when a message FPH authentication mode selected by the recipient is recipient confirmation authentication mode, the apparatus further comprises:
a deduction confirming module, adapted to send a deduction confirmation message to the recipient, and receive the answer returned by the recipient in response to the deduction confirmation message;
a response time setting module, adapted to set a response time; and
a response time control module, adapted to determine that the recipient rejects to pay for the short message of the sender if the recipient does not answer the deduction confirmation message within the response time.

17. A message FreePhone (FPH) apparatus, comprising:
an authenticating module, adapted to authenticate a message recipient for paying for the message forwarded by the message forwarding apparatus;
a charging apparatus, adapted to send a deduction instruction to the charging apparatus after the authentication is performed by the authenticating module successfully, and receive the deduction result fed back by the charging apparatus; and
a sending confirming module, adapted to send a message sending instruction to the message forwarding apparatus when the deduction result received by the charging module indicates success.

18. The message FPH apparatus of claim 17, wherein the authenticating module comprises:
a mode analyzing submodule, adapted to analyze the message FPH authentication mode of the recipient and generate an analysis result; and
a mode executing submodule, adapted to execute the message FPH authentication mode and authenticate according to the analysis result of the mode analyzing submodule.

19. The message FPH apparatus of claim 17, wherein the charging module comprises:
an information querying submodule, adapted to query the charging apparatus about the account information of the recipient; and
a charging executing submodule, adapted to send a deduction command to the charging apparatus according the message sent by the sender.

20. The message FPH apparatus of claim 17, further comprising:
a service activating module, adapted to activate the message FPH service for the recipient and select a message FPH authentication mode.

21. The message FPH apparatus of claim 20, wherein the service activating module comprises:
a mode selecting submodule, adapted to select the message FPH authentication mode of the message FPH service for the recipient; and
a parameter setting submodule, adapted to set an authorized name list or free areas or free time segments according to the message FPH authentication mode selected by the mode selecting submodule.
